(19) United States
(12) Patent Application Publication
(10) Pub. No.: US 2008/0178429 A1
(43) Pub. Date: Jul. 31, 2008

(54) Carriage

(75) Inventor: Reinhard Haselsteiner, Deuerling (DE)

Correspondence Address: ROTHWELL, FIGG, ERNST & MANBECK, P.C., 1425 K STREET, N.W., SUITE 800, WASHINGTON, DC, 20005, US

(73) Assignee: HANS HEIDOLPH GMBH & CO., KG, Kelheim (DE)

(21) Appl. No.: 11/911,264

(22) PCT Filed: Mar. 18, 2006
(86) PCT No.: PCT/DE06/00485

§ 371 Date: Oct. 11, 2007

(30) Foreign Application Priority Data
Apr. 13, 2005 (DE) 10 2005 016 991.0

(51) Int. Cl. B60B 33/00

(52) U.S. Cl. 16/35 R

(57) ABSTRACT

A carriage is described, in particular for transporting medical devices in hospitals, comprising a carrier (2) for bearing a load to be transported, at least three, preferably four casters (5) arranged in a roller plane having caster swivels (6), on which the carrier (2) rests, at least two of the caster swivels (6) being adapted for pivoting around a geometric rotational axis (7) which runs perpendicular to the roller plane, and a fixing mechanism (15), by which the carriage (1) can be secured against rolling away. According to the present invention, the fixing mechanism (15) has locking devices (17) coupled to an actuating element (16), by which the at least two of the rotatable caster swivels (6) are lockable, by actuating the actuating element (16), in different rotational angle positions in such a manner that the casters (5) fastened thereto are oriented differently.

The present invention relates to a carriage, in particular for transporting medical devices in hospitals, comprising a carrier for bearing a load to be transported, at least three, preferably four casters arranged in a roller plane having caster swivels, on which the carrier rests, at least two of the caster swivels being adapted for pivoting around a geometric rotational axis, which runs perpendicular to the caster plane, and a fixing mechanism, by which the carriage can be secured against rolling away.

In hospitals, medical devices have to be able to be set up rapidly next to a bed of a patient as needed. For this purpose, carriages are required, on which devices can be pushed back and forth rapidly and safely between various rooms. In order that such a carriage can be pushed rapidly in any arbitrary direction, the caster swivels are rotatable around a geometric rotational axis which runs perpendicular to the roller plane. Carriages of this type are also referred to as trolleys.

A fixing mechanism is necessary so that the carriage can be secured against rolling away and medical devices can be used on the carriage next to a patient bed without danger of accident.

Known carriages have a brake as a fixing mechanism for each caster, which can be actuated using the foot by a small lever on the particular caster swivel, for example. To secure the carriage against undesired movements, at least two brakes must be actuated separately in carriages of this type, which is cumbersome and requires valuable time in cases of emergency. Namely, if only one caster is braked, the carriage can execute a rotational movement around the braked caster because of the rotatable caster swivels. The danger also exists with known brakes that their braking force is inadequate, particularly in the event of negligent actuation of the brake, so that a danger of accident arises due to undesired movements of the carriage.

An object of the present invention is therefore to indicate a way in which a carriage of the type cited at the beginning can be secured against rolling away with greater reliability by an easily operable fixing mechanism.

The object is achieved according to the present invention in that the fixing mechanism has locking devices coupled to an actuating element, by which at least two of the pivotable caster swivels are lockable by actuating the actuating element in different rotational angle positions, such that the casters fastened thereto are oriented differently.

In a carriage according to the present invention, brakes for the individual casters can be dispensed with. Reliable securing against rolling away is already achieved in that the at least two caster swivels are locked, so that they are no longer rotatable around the particular geometric rotational axis which runs perpendicular to the roller plane. Advantageously, this can be achieved by actuating a single actuating element, so that the fixing mechanism of a carriage according to the present invention allows rapid and reliable securing against rolling and rotational movements.

It is important that the caster swivels are locked in an angular position such that the casters of the locked caster swivels are oriented differently, i.e., are not parallel to one another. It is especially favorable to lock the caster swivels in such a manner that the associated casters are at an angle of 30° to 45° to one another. This angle specification relates to the acute angle between straight lines in the direction of the particular caster orientation.

All caster swivels are preferably pivotable in a carriage according to the present invention. The fixing mechanism according to the present invention can also be used for carriages, however, in which only two front caster swivels are rotatable and two rear caster swivels are rigidly connected to the carrier, so that the two rear casters are always parallel to one another. However, a carriage of this type can not be pushed in any arbitrary direction, thus, four pivotable caster swivels are preferred.

In principle, it is sufficient to lock two rotatable caster swivels of the carriage are locked in the way described. The carriage can be secured against rolling away especially reliably by locking four rotatable caster swivels simultaneously. The four caster swivels can even be locked in such a manner that casters arranged diagonally opposite are oriented parallel to one another, as long as at least one of the two other casters has an orientation deviating therefrom, preferably by 45°.

An important advantage of a carriage according to the present invention is particularly that, in contrast to the brakes typical in the prior art, no wearing parts are needed for the fixing mechanism. Thus, not only maintenance costs can be reduced, but rather also greater reliability of the fixing mechanism results.

Further details and advantages of the present invention are explained in the following on the basis of the figures. The special features shown and described therein can be used individually or in combination to provide preferred embodiments of the present invention.

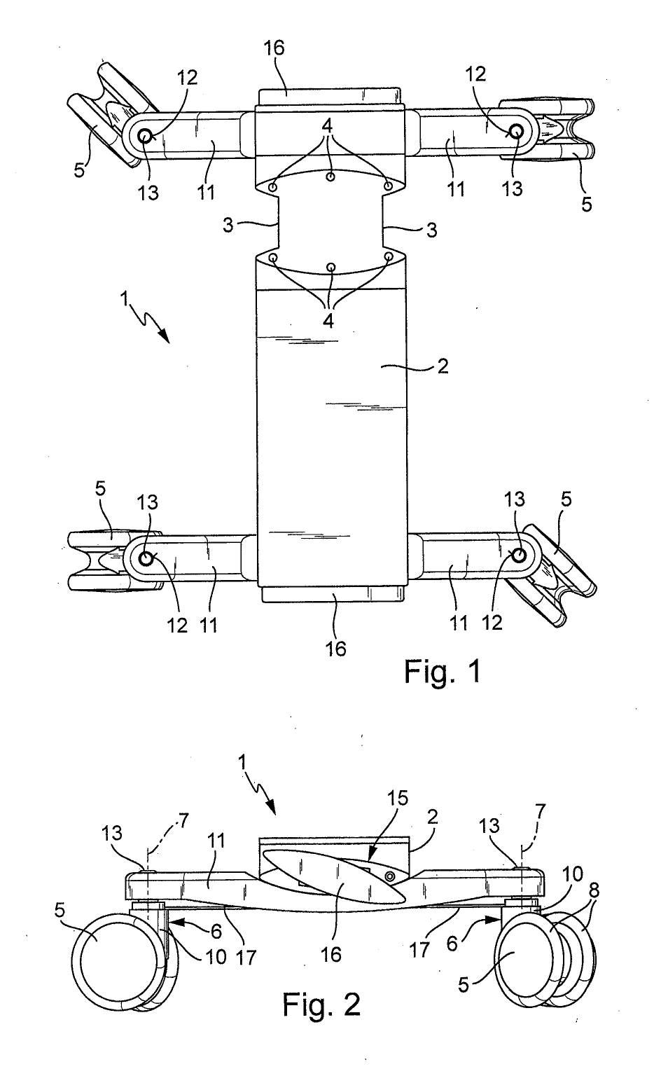

FIG. 1 shows an exemplary embodiment of a carriage according to the present invention in a top view;

FIG. 2 shows the exemplary embodiment shown in FIG. 1 in a side view;

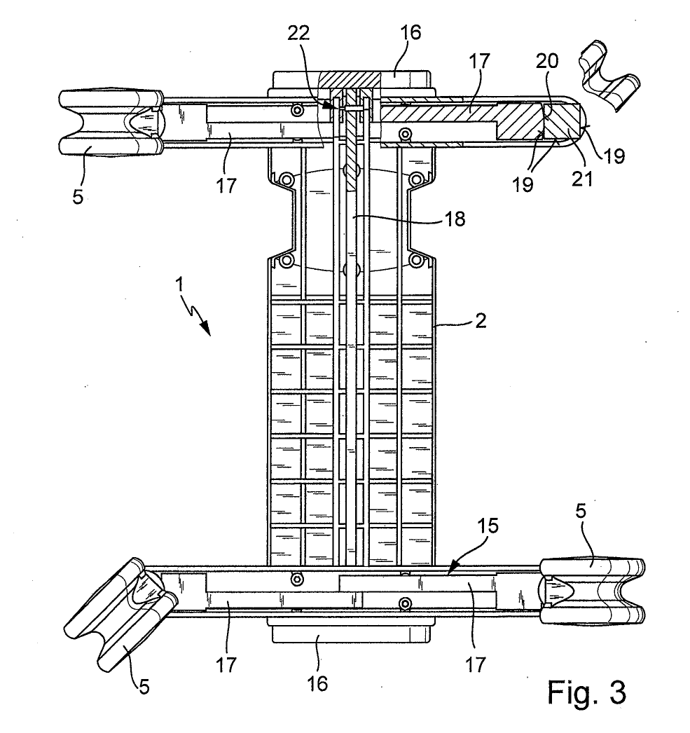

FIG. 3 shows the exemplary embodiment shown in FIG. 1 in a partial section from below;

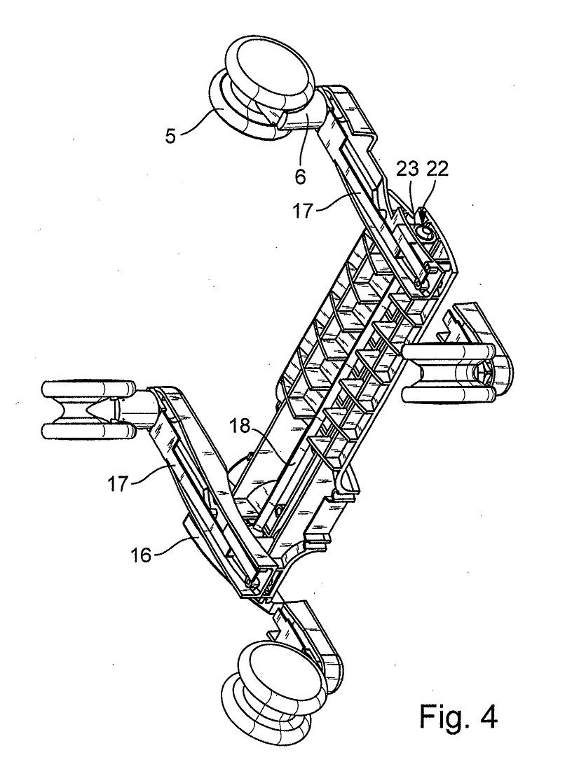

FIG. 4 shows the exemplary embodiment shown in FIG. 1 in a partial diagonal section from below;

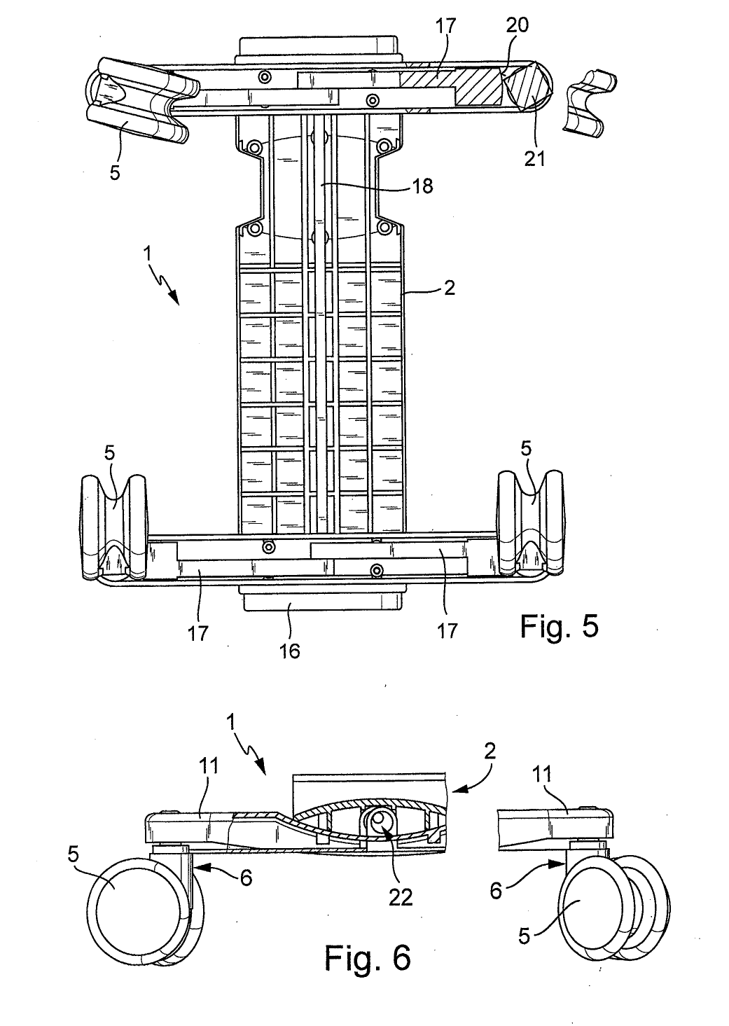

FIG. 5 shows the exemplary embodiment shown in FIG. 1 in a partial section from below; and

FIG. 6 shows the exemplary embodiment shown in FIG. 1 in a partial section from the side.

The non-driven carriage 1 shown in FIG. 1 is used for transporting medical devices in hospitals. It comprises a carrier 2 for bearing a load to be transported, which is provided with lateral recesses 3, so that a medical device having a matching shaped base can be fastened in a defined position on the carrier 2. To secure the load, the carrier 2 has fastening holes 4, into which fastening pins or pegs can be plugged to reliably prevent slipping of the load.

In the exemplary embodiment shown, four casters 5 arranged in a roller plane are provided, on which the carrier 2 rests. In principle, three casters 5 are sufficient if they are arranged in a suitable manner on the carrier 2. However, a carriage having four casters 5 has the advantage of greater stability and is better protected from tipping over.

As can be seen in FIG. 2 in particular, the casters 5 are fastened to the carrier 2 by a caster swivel 6, the caster swivels 6 being pivotable around a geometric rotational axis 7 which runs perpendicular to the roller plane. In this manner, the carriage 1 can be shifted in any arbitrary direction, because the casters 5 orient themselves in the thrust direction by rotation of the caster swivels 6.

For stability reasons, casters 5 are preferred which are formed by a wheel pair 8, between which a column 10 of the caster swivel 6 extends. The column 10 of the caster swivel 6 is arranged offset neighboring the center of the two wheels 8, so that the casters 5 orient themselves more rapidly in the thrust direction upon pushing of the carriage 1.

The caster swivels 6 are fastened to projecting arms 11 of the carrier 2 so that they are rotatable. In this manner, the tilting stability of the carriage is increased still further. The carrier arms 11 are provided with circular openings 12, through which a fastening pin 13 of the caster swivel 6 is guided so it is rotatable.

The carriage 1 has a fixing mechanism 15, by which it can be secured against rolling away. The fixing mechanism 15 has locking devices 17 coupled to an actuating element 16, by which the casters 5 are lockable simultaneously, by actuating of the actuating element 16 different in rotational angle positions, so that at least two casters 5 are oriented differently. The carriage with an activated fixing mechanism 15 is shown in FIG. 1. As shown, neighboring casters 5 are at an angle of 45° to one another in each case. The carriage 1 is reliably secured against rolling away in this way, because at least two casters 5 are oriented incorrectly for any arbitrary caster direction and therefore oppose a movement. This effect is achieved even if, as in the exemplary embodiment shown, diagonally opposite arranged casters 5 run parallel to one another, i.e., are oriented identically, if at least one, preferably both other casters 5 are oriented differently.

The actuating element 16 of the fixing mechanism 15 is well visible in the side view shown in FIG. 2. The actuating element 16 is implemented as a rocker lever, which is connected to a shaft 18 shown in FIG. 3. The carriage 1 is shown partially cut away in a detail (top right) in FIG. 3 for better illustration.

The actuating element 16 can be pressed down, using the foot, for example, by which the shaft 18 is put in rotation. In the exemplary embodiment shown, an actuating element 16 is attached to each end of the shaft 18, so that the fixing mechanism 15 can be actuated from two sides of the carriage 1.

The locking devices of the fixing mechanism 15 comprise locking rods 17 shown in FIGS. 2 through 5, which come into contact with the caster swivels 6 for locking. As shown on the top right in FIG. 3, the locking rods 17 have an end with a locking face 20, which cooperates for locking with a locking face 19 of the caster swivels 6.

In the exemplary embodiment shown, the locking faces 19 of the caster swivels 6 are formed by locking parts 21 in the form of square plates, which are connected rotationally fixed to the remaining parts of the respective caster swivel 6. Thus, a plurality of, preferably four locking faces 19 are provided for each caster swivel 6, the locking faces 19 are arranged around the respective geometric rotational axis 7 of the caster swivel 6.

If the locking face 20 of a locking rod 17 presses against the locking face 19 of the caster swivel 6, the respective caster swivel 6 is locked in its respective rotational angle position by the geometric shape of the locking faces 19, 20. The locking faces 19 of the caster swivels 6 are preferably essentially planar. The locking faces 20 of the locking rods 17 can also be planar. A middle area of the locking faces 20 of the locking rods 17 preferably projects somewhat beyond their edges, as shown in FIG. 3. The locking faces 20 are each composed of two sections arranged at obtuse angles. These sections preferably enclose an angle of 160° to 180°, preferably 170° to 175°. Thus, after contact of the locking faces 19, 20, the caster swivels are rotatable more easily into their locking position shown in FIG. 3 and the fixing mechanism can not be impeded with by jamming.

Play of the fixing mechanism 15 can be minimized in that the locking faces 19, 20 of the locking rods 17 and the caster swivels 6 and/or sections of the locking faces 20 which press against one another are completely planar. However, reliable securing against rolling away can also be achieved if the caster swivels 6 have some play in their locked state, therefore slight irregularities of the locking faces 19, 20, such as a slightly convex shape, are harmless. Essentially planar is therefore understood in the context of the present application as a face which only has such slight deviations from a geometrically perfect plane that play of the fixing mechanism 15 resulting therefrom is so slight that the orientation of the respective casters 5 can only change so slightly after actuating the fixing mechanism 15 that the carriage 1 is reliably secured against rolling away.

It is important that in at least one caster swivel 6, the locking faces 19 are oriented differently in relation to the caster 5 fastened thereto than in the remaining caster swivels 6, so that after actuating the fixing mechanism, at least one caster 5 points in a different direction than the remaining casters 5. In the exemplary embodiment shown, the locking part 21 having a square cross section is oriented in two caster swivels 6 in such a manner that two of its locking faces 19 are oriented parallel to the casters 5 and the other two locking faces 19 are oriented perpendicular to the casters 5. In the other two caster swivels 6, the square 21 is oriented in such a manner that its locking faces 19 are at an angle of 45° to the casters 5.

The functional principle of the fixing mechanism 15 can be understood particularly well by a comparison of FIGS. 3 and 5. The top right of FIG. 3 shows how the locking face 20 of the locking rod 17 abuts the locking face 19 of the locking bar 21, so that the caster swivel 6 can no longer rotate. For comparison, the locking rod 17 is shown in a retracted position on the top right in FIG. 5, so that there is a sufficient distance between the locking face 20 and the locking part 21 to allow rotation of the caster swivel 6.

The locking rods 17 are shifted back and forth between the positions shown in FIGS. 3 and 5 by rotating the actuating element 16. A rotational movement of the actuating element 16 is converted via the shaft 18 and an eccentric into a translation movement of the locking rods 17. The displacement path of the locking rods 17 is preferably dimensioned in such a manner that the locking faces 19, 20 of the caster swivels 6 and the locking rods 17 press flat against one another in the locked state. However, it is also possible to dimension the displacement path of the locking rods 17 somewhat shorter, so that a small gap remains between the participating locking faces 19, 20 in each case. Such a gap would have the result that the caster swivels 6 can still rotate slightly even in the locked state, namely until the right or left edge of the respective locking face 19 of the caster swivel 6 abuts the locking face 20 of a locking rod 17. As already noted, the functioning of the fixing mechanism described is not effected if the casters 5 are rotatable by a few degrees in the locked state.

The fixing mechanism 15 comprises an eccentric 22 shown in FIGS. 3, 4, and 6; rotation of the eccentric 22 effects the locking rods 17 to be shifted toward the caster swivels 6 to be blocked. In the exemplary embodiment shown, eccentrics 22 are provided on both ends of the shaft 18, via which two locking rods 17 can be pushed toward the caster swivels 6 to be blocked by a rotational movement of the shaft 18 or can be retracted in the reverse rotational direction.

The eccentrics 22 are preferably self-locking eccentrics, so that rotation of the shaft 18 and displacement of the locking rods 17 can not occur unintentionally. Self locking of the eccentric can be achieved by a suitably selected eccentric pitch or a catch mechanism, for example.

As can be seen in FIG. 4 in particular, in the exemplary embodiment shown, the locking rods 17 are implemented as plates, which are widened to form the locking face 20 on their end facing toward the caster swivel 6 to be blocked. On their end facing toward the shaft 18, the plates forming the locking rods 17 are provided with a tab 23. The tab 23 has an eccentric opening, through which the shaft 18 is guided connected rotationally fixed to the tab 23, by which the eccentric 22 is formed. Advantageously, the locking rods 17 can be manufactured cost-effectively in this manner by punching out and bending the tab 23.

### LIST OF REFERENCE NUMERALS

1 carriage
2 carrier
3 recesses
4 fastening holes
5 casters
6 caster swivel
7 geometric rotational axis
8 wheels
10 column
11 arms
12 openings
13 fastening pegs
15 fixing mechanism
16 actuating element
17 locking rods
18 shaft
19 locking faces of the caster swivels
20 locking faces of the locking rods
21 locking part
22 eccentric
23 tab

1. A carriage, in particular for transporting medical devices in hospitals, comprising:
a carrier (2) for bearing a load to be transported,
at least three, preferably four casters (5) arranged in a roller plane and having caster swivels (6), on which the carrier (2) rests, at least two of the caster swivels (6) being adapted for pivoting around a geometric rotational axis (7) which runs perpendicular to the roller plane, and
a fixing mechanism (15), by which the carriage (1) can be secured against rolling away,
characterized in that
the fixing mechanism (15) comprises locking devices (17) coupled to an actuating element (16), wherein by means of the locking devices (17), at least two of the pivotable caster swivels (6) are lockable, by actuating the actuating element (16), in different rotational angle positions in such a manner that the two casters (5) fastened thereto are oriented differently.

2. The carriage according to claim 1, characterized in that the casters (5) of at least two caster swivels (6) locked by the locking devices (17) are oriented at an angle of 30° to 45° to one another.

3. The carriage according to claim 1, characterized in that all caster swivels (6) are rotatable around a geometric rotational axis (7) which runs perpendicular to the caster plane.

4. The carriage according to claim 1, characterized in that all pivotable caster swivels (6) are lockable by means of the locking devices (17).

5. The carriage according to claim 1, characterized in that the locking devices comprise at least one displaceable locking rod (17), which contacts a caster swivel (6) for locking,

6. The carriage according to claim 5, characterized in that the locking rod (17) has a locking face (20) at one end thereof, which locking face (20) cooperates for locking with a locking face (19) of the caster swivel (6) which is to be locked.

7. The carriage according to claim 6, characterized in that the locking face (19) of the caster swivel (6) is essentially planar.

8. The carriage according to claim 6, characterized in that the at least two caster swivels (6), which are lockable in different rotational angle positions have locking faces (19) which are oriented relative to their respective casters (5) differently from each other.

9. The carriage according to claim 6, characterized in that the locking face (20) of the locking rod (17) is essentially planar.

10. The carriage according to claim 9, characterized in that the locking face (20) of the locking rod (17) has two sections, which are arranged at an obtuse angle to one another.

11. The carriage according to claim 9, characterized in that the obtuse angle is between 160° and 180°, preferably between 170° and 175°.

12. The carriage according to claim 6, characterized in that the rotatable caster swivel (6) has a plurality of locking faces (19), which are arranged around the geometrical rotational axis (7).

13. The carriage according to claim 12, characterized in that the locking faces (19) of at least one caster swivel (6) are arranged on a locking part (21), through which the geometric rotational axis (7), around which the caster swivel (6) is rotatable, runs.

14. The carriage according to claim 13, characterized in that the locking part (21) has a square or hexagonal cross section.

15. The carriage according to claim 1, characterized in that the actuating element (16) is coupled to locking devices for simultaneously locking four caster swivels (6).

16. The carriage according to claim 1, characterized in that the actuating element (16) is connected to a shaft (18) for effecting the locking of the caster swivels (6) upon actuation of the actuating element (16).

17. The carriage according to claim 5, characterized in that the fixing mechanism (15) comprises at least one eccentric (22), wherein rotating the eccentric (22) causes shifting of at least one locking rod (17) toward the caster swivel (6) for blocking.
